(19) United States
(12) Patent Application Publication
(10) Pub. No.: US 2004/0110583 A1
(43) Pub. Date: Jun. 10, 2004

(54) Transmission system for motor bikes

(76) Inventor: See-Bin Liang, Taichung City (TW)

Correspondence Address: CHARLES E. BAXLEY, ESQUIRE, Hart, Baxley , Daniels & Holton, 59 John St, 5 Fl, New York, NY, 10038, US

(21) Appl. No.: 10/313,469

(22) Filed: Dec. 4, 2002

(51) Int. Cl. F16H 55/56; F16H 61/00

(52) U.S. Cl. 474/14; 474/8

(57) ABSTRACT

A transmission system includes a shaft and a first disk is fixedly mounted to the shaft and a second disk is movably mounted to the shaft. Each of the first disk and the second disk includes an inclined surface which face with each other. The second disk has a third inclined surface located in opposite to the second inclined surface. A cap is fixedly mounted to the shaft and a plurality of pushing members are pivotably connected to the cap. The pushing members each have a distal end so as to push the third inclined surface of the second disk toward the first disk when the shaft is rotated. A belt reeves around the shaft and is movably clamped between the first inclined surface and the second inclined surface.

### FIELD OF THE INVENTION

The present invention relates to a transmission system for motor bikes and uses a belt movably clamped between two movable tapered surfaces of two disks, and one of the disks being pushed by two pivotable members by eccentric force when the disks are rotated.

### BACKGROUND OF THE INVENTION

A conventional transmission system is shown in FIG. 1 and generally includes a shaft 10 driven by a motor (not shown) engaged with the passage 101 in the shaft 10. A first disk 11 and a second disk 12 are respectively mounted to the shaft 10 wherein the first disk 11 cannot moved relative to the shaft 10 and the second disk 12 is movable along the shaft 10. The two disks 11, 12 each have an inclined surface 112/122 and the two inclined surfaces 112, 122 face toward each other. Each of the first disks 11 and the second disks 12 has a recessed area 114/124 defined in the other side opposite to the inclined surface 112/122. A cap 14 is fixedly mounted to the shaft 10 and two pushing members 13 are movably retained in the recessed area 124 by the cap 14. A belt 25 is mounted to the shaft 10 and clamped between the two inclined surfaces 112 and 122, so that when the shaft 10 rotates, the belt 25 is rotated and outputs a torque at a speed. When the shaft 10 is rotated, the pushing members 13 move outward by the eccentric force and the movement of the pushing members 13 pushes the second disk 12 toward the first disk 11 such that the belt 25 is pushed outward by the two inclined surfaces 112, 122. The inner diameter that the belt 25 is rotated about is then increased and the speed can be changed. Nevertheless, the pushing members 13 cannot be controlled precisely so that in a situation as shown in FIG. 2, the pushing members 13 could be stocked at the outmost positions and prohibit the movement of the second disks 12.

The present invention intends to provide a transmission system wherein the pushing members are two pivotable members connected to the cap so that the movement of the pivotable members can be positively controlled.

### SUMMARY OF THE INVENTION

In accordance with one aspect of the present invention, there is provided a transmission system which comprises a shaft driven by a motor and a first disk is fixedly mounted to the shaft and includes a first inclined surface. A second disk is movably mounted to the shaft and includes a second inclined surface which faces the first inclined surface. The second disk has a third inclined surface and is located in opposite to the second inclined surface.

A cap is fixedly mounted to the shaft and a plurality of pushing members are pivotably connected to the cap. The pushing members each have a distal end so as to push the third inclined surface of the second disk toward the first disk. A belt reeves around the shaft and is movably clamped between the first inclined surface and the second inclined surface.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a cross sectional view to show a conventional transmission system;

FIG. 2 shows the pushing members in conventional transmission system are stocked by the cap;

FIG. 3 is an exploded view to show the transmission system of the present invention;

FIG. 4 shows the frame in the cap in the transmission system of the present invention when the shaft is not rotated;

FIG. 5 is a cross sectional view to show the transmission system of the present invention when the shaft is not rotated;

FIG. 6 shows the frame in the cap in the transmission system of the present invention when the shaft is rotated;

FIG. 7 is a cross sectional view to show the transmission system of the present invention when the shaft is rotated;

FIG. 8 shows the transmission system of the present invention is cooperated with a mechanism of motor bike wherein the diameter of the belt is small;

FIG. 9 shows the transmission system of the present invention is cooperated with a mechanism of motor bike wherein the diameter of the belt is large;

FIG. 10 is a cross sectional view to show another embodiment of the transmission system of the present invention when the shaft is not rotated, and

FIG. 11 is a cross sectional view to show the transmission system in FIG. 10 when the shaft is rotated.

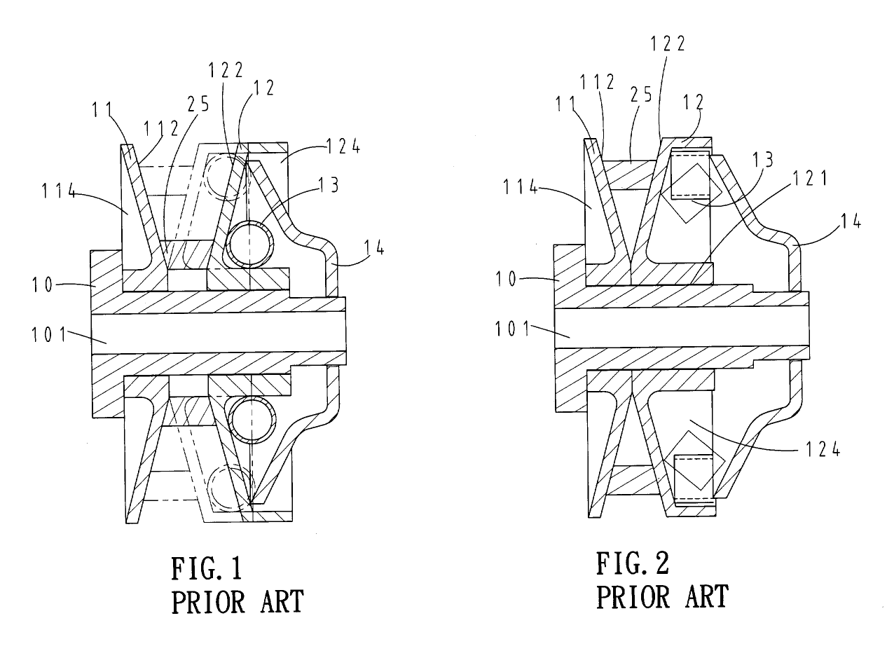

### DETAILED DESCRIPTION OF THE PREFERRED EMBODIMENT

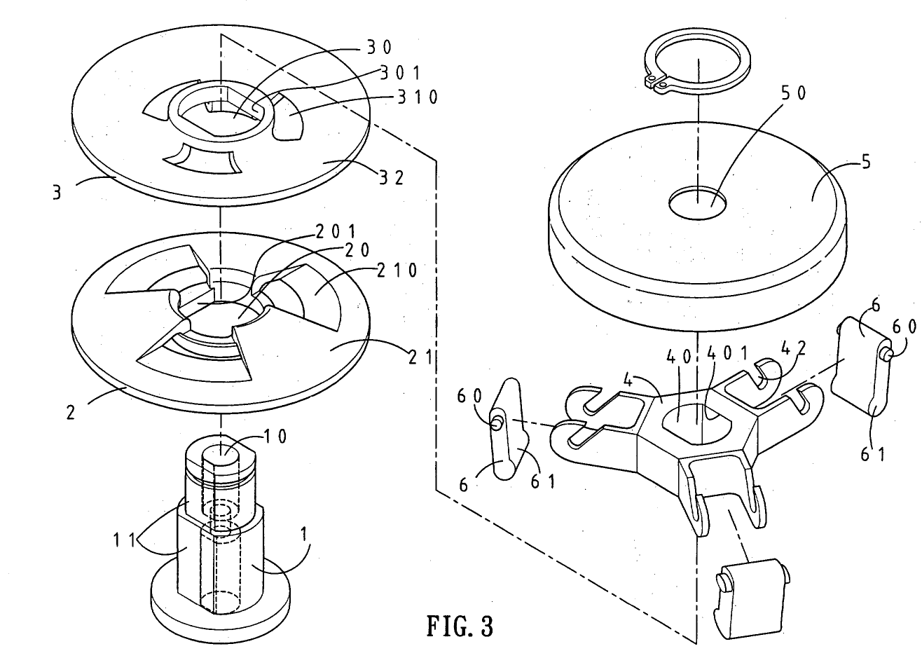

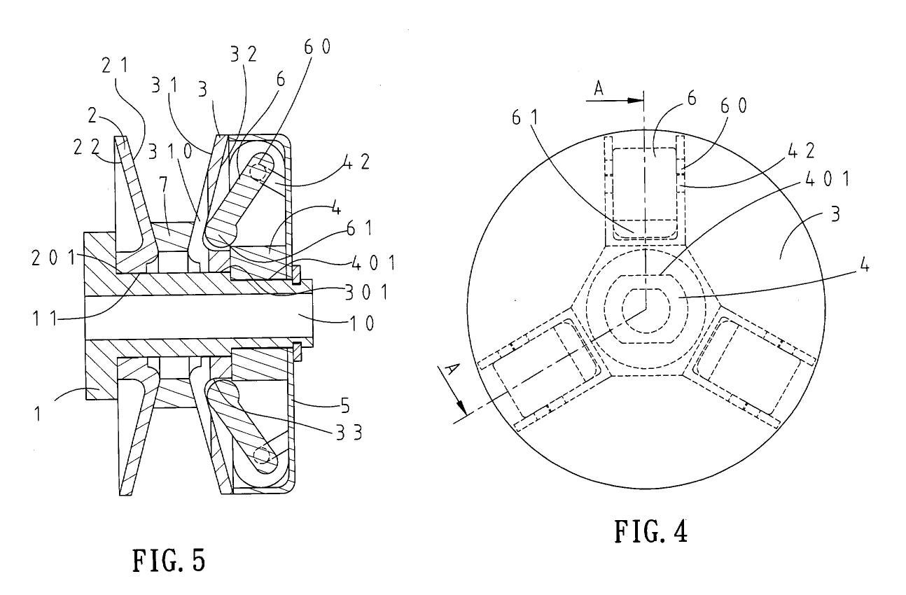

Referring to FIGS. 3 to 5, the transmission system of the present invention for motor bike comprises a shaft 1 which has a passage 10 for being engaged with a motor shaft (not shown) and two flat surfaces 11 on an outer periphery of the shaft 1. A first disk 2 has a central hole 20 with two flat surfaces 201 and is fixedly mounted to the shaft 1. The first disk 2 includes a first inclined surface 21 on a first side thereof and a plurality of apertures 210 defined through the first disk 2.

A second disk 3 has a central hole 30 with two flat surfaces 301 and is movably mounted to the shaft 1. The second disk 3 includes a second inclined surface 31 which faces the first inclined surface 21, and a third inclined surface 32 located in opposite to the second inclined surface 31. The second disk 3 has a plurality of apertures 310 defined therethrough. A groove 33 is defined in an outer periphery of a base portion of the second disk 3 and the third inclined surface 32 extends from the groove 33.

A cap 5 is fixedly mounted to the shaft 1 by a C-shaped clamp and a frame 4 is received in the cap 5. The frame 4 has a central hole 40 with two flat surfaces 401 and is mounted to the shaft 1. Three extension portions extending from the frame 4 and each extension portion has a hook portion 42. Three pushing members 6 each have two rods 60 on two sides thereof so as to be pivotably engaged with the hook portion 42. The pushing members 6 each have a rounded distal end 61 which is to push the third inclined surface 32 of the second disk 3 toward the first disk 2. The rounded distal end 61 is engaged with the groove 33 when the shaft 1 is not rotated.

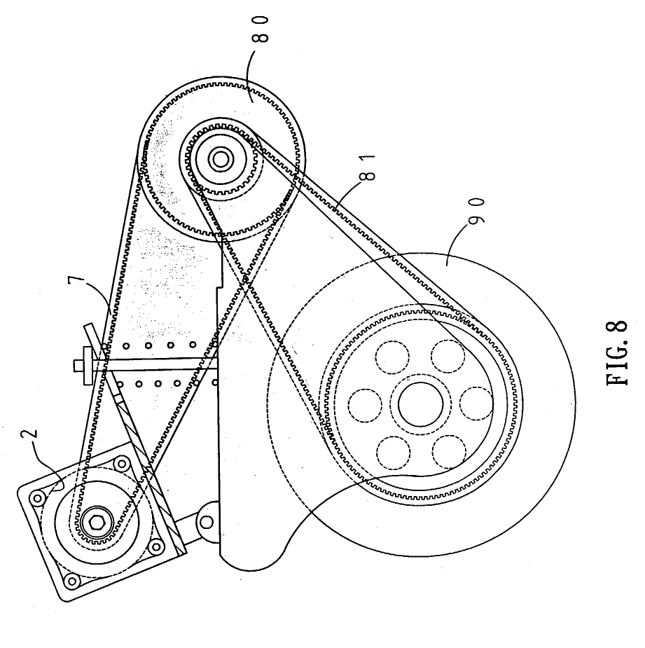

A belt 7 reeves around the shaft 1 and is movably clamped between the first inclined surface 21 and the second inclined surface 31. Referring to FIG. 8, the belt 7 is cooperated with a mediate wheel 80 which is cooperated with a wheel 90 by another belt 81 so that when the shaft 1 is rotated, the belts 7 and 81 transfer the transmission force to the wheel 90.

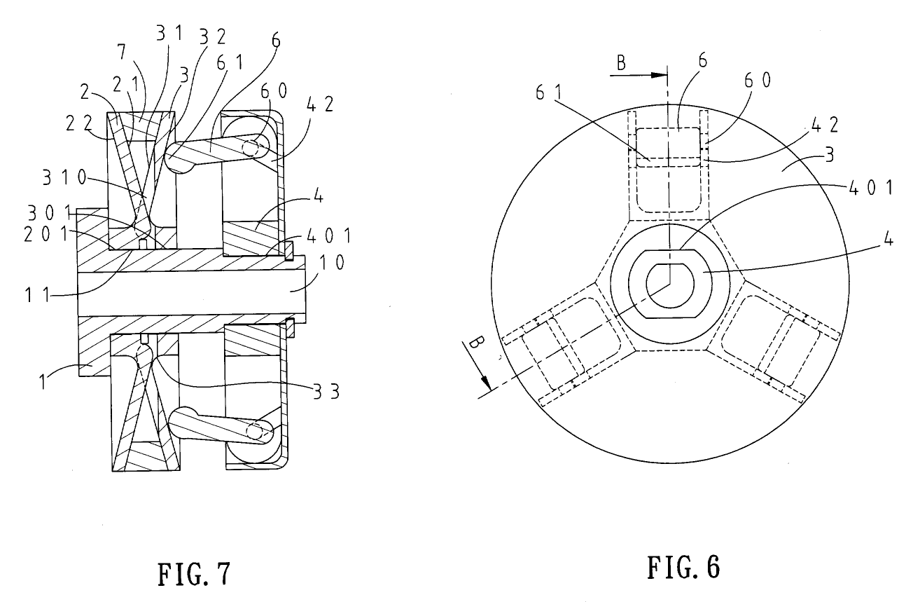

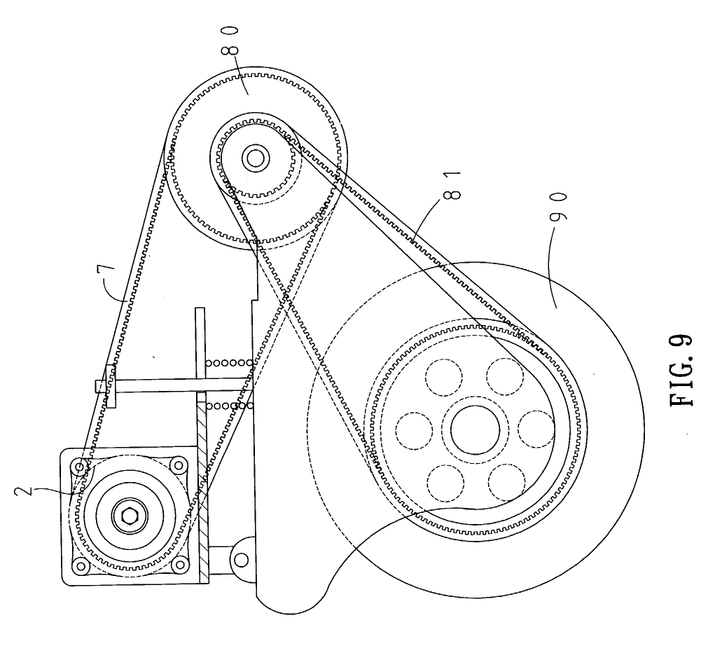

Referring to FIGS. 6 and 7, when the shaft 1 is rotated, the pushing members 6 are pivoted by the eccentric force of the rotation so that the rounded distal ends of the pushing members 6 leave from the groove 33 and push the third inclined surface 32 of the second disk 3 toward the first disk 2. The belt 7 is then forced to raised and the diameter that the belt 7 reeves is increased as shown in FIG. 9. A part of the first disk 2 extends in the apertures 310 when the second disk 3 moves toward the first disk 2.

The pushing members 6 will never be stocked and is easily to be maintained or replaced.

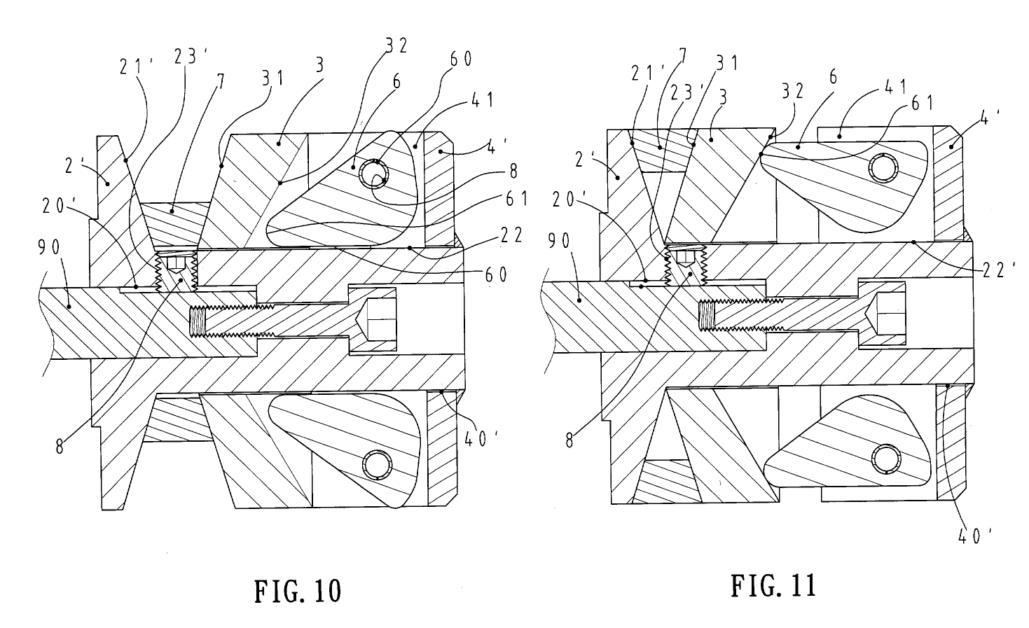

Referring to FIG. 10, the shaft 22′ and the first disk 2′ are made into a one-piece member and the driving shaft 90 is fixedly received in the passage 20′ of the shaft 22′ by a locking screw 9 extending into a radial hole 23′ in the sahft 22′. The second disk 3 is movably mounted to the shaft 22′ and the belt 7 is movably clamped between the first inclined surface 21′ of the first disk 2′ and the second inclined surface 31 of the second disk 3. The cap 4′ is fixedly mounted to the shaft 22′ and two pushing members 6 are pivotably connected to the cap 4. Each of the pushing members 6 has a flat side 60 which lies on an outer periphery of the shaft 22′ when the shaft is not rotated. When the shaft 22′ is rotated by the driving shaft 90, the pushing members 6 are pivoted and the distal ends 61 push the third inclined surface 32 to move the second disk 3 toward the first disk 2′.

While we have shown and described the embodiment in accordance with the present invention, it should be clear to those skilled in the art that further embodiments may be made without departing from the scope of the present invention.

What is claimed is:

1. A transmission system comprising:
a shaft;
a first disk fixedly mounted to the shaft and including a first inclined surface;
a second disk movably mounted to the shaft and including a second inclined surface which faces the first inclined surface, the second disk having a third inclined surface located in opposite to the second inclined surface;
a cap fixedly mounted to the shaft and a plurality of pushing members pivotably connected to the cap, the pushing members each having a distal end so as to push the third inclined surface of the second disk toward the first disk, and
a belt reeving around the shaft and movably clamped between the first inclined surface and the second inclined surface.

2. The device as claimed in claim 1, wherein the distal end of each of the pushing members is a rounded end and a groove is defined in an outer periphery of a base portion of the second disk, the third inclined surface extending from the groove in which the distal end is engaged when the shaft is not rotated.

3. The device as claimed in claim 1, wherein the second disk has a plurality of apertures defined therethrough so that a part of the first disk extends in the apertures when the second disk moves toward the first disk.

4. The device as claimed in claim 1 further comprising a frame received in the cap and mounted to the shaft, three extension portions extending from the frame and each extension portion having one of the pushing members pivotably connected thereto.

5. The device as claimed in claim 4, wherein each extension portion includes a hook portion and each pushing member has two rods which are pivotably engaged with the hook portion.

6. The device as claimed in claim 1, wherein each of the pushing members has a flat side which lies on an outer periphery of the shaft when the shaft is not rotated.

7. The device as claimed in claim 1, wherein each of the pushing members has a flat side which lies on an outer periphery of the shaft when the shaft is not rotated.
